(19) United States
(12) Patent Application Publication
(10) Pub. No.: US 2006/0136262 A1
(43) Pub. Date: Jun. 22, 2006

(54) System and method for creating and maintaining dynamic offset times for healthcare orders in a computerized environment

(75) Inventors: Michael A. Ash, Parkville, MO (US); John Q. DeVerter, Liberty, MO (US)

Correspondence Address: SHOOK, HARDY & BACON L.L.P.;Intellectual Property Department, 2555 GRAND BOULEVARD, KANSAS CITY, MO, 64108-2613, US

(73) Assignee: CERNER INNOVATION, INC.

(21) Appl. No.: 11/021,531

(22) Filed: Dec. 22, 2004

(51) Int. Cl. G06Q 10/00; G06Q 40/00

(52) U.S. Cl. 705/2; 705/4

(57) ABSTRACT

A system and method for determining the start time of one or more healthcare orders in a computing environment is provided. A start time of a healthcare plan is received. The healthcare plan comprises two or more healthcare orders for a patient. A first offset time for a first healthcare order in the healthcare plan is received. The first offset time is the difference between when the healthcare plan begins and when the first healthcare order begins. A start time for the first healthcare order is determined based on the start time of the healthcare plan and the first offset time for the first healthcare order.

### CROSS-REFERENCE TO RELATED APPLICATIONS

Not applicable.

### STATEMENT REGARDING FEDERALLY SPONSORED RESEARCH OR DEVELOPMENT

Not application.

### TECHNICAL FIELD

The present invention relates generally to the field of computer software. More particularly, the invention relates to a system and method for creating and maintaining dynamic offset times for healthcare orders in a computerized environment.

### BACKGROUND

When a patient needs healthcare treatment such as a medication, diagnostic test, laboratory tests, counseling, nursing care or any other type of healthcare treatment, an order is placed for the particular treatment. Historically, a healthcare provider captured orders by writing on a piece of paper. Then, each individual order was transferred to the appropriate area or department to be filled. For instance, a paper order for a medication would be transferred to the pharmacy, a paper order for a laboratory test would be sent to the lab, and nursing orders would be given to a nurse as a task.

Due to increased technology, many healthcare orders are now placed in a computerized environment. Once an order for healthcare treatment is placed, it is dispersed to the appropriate electronic application to be filled. For example, a medication order is transferred to, an electronic pharmacy application to be filled. Historically, orders placed in a computerized environment are designated a start time. For example, a medication may be ordered to be administered at 9:00 p.m. on Monday. If a change needs to be made to the start time of the order, the change must be made manually. For instance, if the medication time were to begin at 11:00 p.m., the order would need to be opened and the administration time changed. However, this is often difficult once the order has already been transferred to the proper electronic application to be filled. Often times, an order must be cancelled and reordered to change the start time for the order. Furthermore, if an order is part of an overall healthcare plan for the patient that comprises multiple orders for treatment, such as orders for medications, laboratory tests, diagnostic tests, consults and nursing care, all of the orders are designated to begin at the same time. However, new healthcare plans are complex and oftentimes the orders need to begin at different times.

Prior computerized solutions have associated the start time of an individual healthcare order with the start time of another healthcare orders. For example, if a first medication were to be administered, in this case, 11:00 p.m., a second medication could be designated to begin two hours after the first medication is administered at 11:00 p.m. If one start time for a healthcare order is changed, then all of the other start times for associated healthcare orders are also changed. In the above example, if the start time of the first medication was changed to 11:00 p.m., then the start time of the second medication would be changed to 1:00 a.m. on the following day. However, if the second medication must to be administered at 11:00 p.m., the patient is at risk. Associating healthcare orders to one another is clinically dangerous as the start time for one healthcare order may be inadvertently changed due to a change of the start time of an associated healthcare order.

What will be beneficial is a system and method for establishing a start time of a healthcare plan having multiple orders. It would be beneficial for the plan to have a designated start time and for the multiple healthcare orders within the plan to have start times established with respect to the start time of the plan. Thus, the start time for each of the individual orders could be changed independently of another order.

### SUMMARY

In one embodiment, the present invention relates to a method for determining the start time of one or more healthcare orders in a computing environment. A start time of a healthcare plan is received. The healthcare plan comprises two or more healthcare orders for a patient. A first offset time for a first healthcare order in the healthcare plan is received. The first offset time is the difference between when the healthcare plan begins and when the first healthcare order begins. A start time for the first healthcare order is determined based on the start time of the healthcare plan and the first offset time for the first healthcare order.

In another embodiment of the present invention, a system for determining the start time of one or more healthcare orders in a computing environment is provided. The system comprises a first receiving component for receiving a start time of a healthcare plan, the plan comprising two or more healthcare orders for a patient and a second receiving component for receiving a first offset time for a first healthcare order in the healthcare plan. The first offset time is the difference between when the healthcare plan begins and when the first healthcare order begins. The system further comprises a determining component for determining a start time of the first healthcare order based on the start time of the healthcare plan and the first offset time for the first healthcare order.

In yet another embodiment, the present invention relates to a system for determining the start time of one or more healthcare orders in a computing environment. The system comprises means for receiving a start time of a healthcare plan, the plan comprising two or more healthcare orders for a patient and means for receiving a first offset time for a first healthcare order in the healthcare plan. The first offset time being the difference between when the healthcare plan begins and when the first healthcare order begins. The system further includes means for determining a start time of the first healthcare order based on the start time of the healthcare plan and the first offset time for the first healthcare order.

### BRIEF DESCRIPTION OF THE SEVERAL VIEWS OF THE DRAWINGS

The present invention is described in detail below with reference to the attached drawing figures, wherein:

FIG. 1 is a block diagram of a computing system environment suitable for use in implementing the present invention;

FIG. 2 is a flow diagram of a method for creating and maintaining offset times for one or more orders of a healthcare plan;

FIG. 3 is a flow diagram of a method for changing offset times between the start time of a healthcare plan and offset time of an order;

FIG. 4 is a flow diagram of a method for creating offset times between the start time of a healthcare plan and offset time for a new order added to the plan;

FIG. 5 is a flow diagram of a method for determining a new start time for each order in a healthcare plan based on a new start time for the healthcare plan and the offset time for each order;

FIG. 6 is a display of a healthcare plan, associated orders, and offset times for the orders in accordance with an embodiment of the present invention;

FIG. 7 is a display of a healthcare plan, associated orders, and a start date and time for the healthcare plan in accordance with an embodiment of the present invention; and

FIG. 8 is a display of a healthcare plan, associated orders, and the changing of offset time of an order in accordance with an embodiment of the present invention.

### DETAILED DESCRIPTION OF THE INVENTION

The present invention provides a system and method for creating and maintaining dynamic offset times for healthcare orders in a computerized environment.

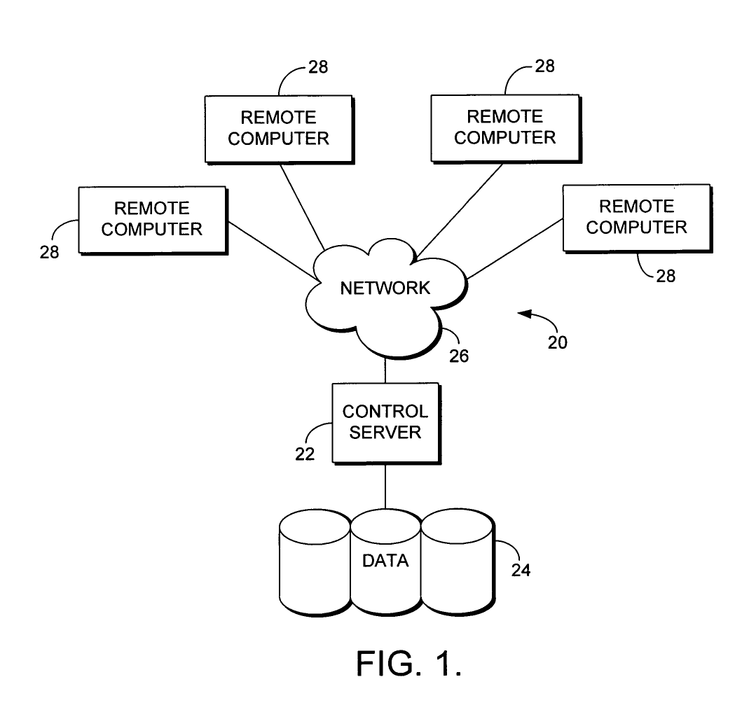

With reference to FIG. 1, an exemplary medical information system for implementing the invention includes a general purpose computing device in the form of server 22. Components of server 22 may include, but are not limited to, a processing unit, internal system memory, and a suitable system bus for coupling various system components, including database cluster 24 to the control server 22. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Server 22 typically includes or has access to a variety of computer readable media, for instance, database cluster 24. Computer readable media can be any available media that can be accessed by server 22, and includes both volatile and nonvolatile media, removable and non-removable media. By way of example, and not limitation, computer readable media may comprise computer storage media and communication media. Computer storage media includes volatile and nonvolatile, removable and nonremovable media implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 22. Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared and other wireless media. Combinations of any of the above should also be included within the scope of computer readable media.

The computer storage media, including database cluster 24, discussed above and illustrated in FIG. 1, provide storage of computer readable instructions, data structures, program modules, and other data for server 22.

Server 22 may operate in a computer network 26 using logical connections to one or more remote computers 28. Remote computers 28 can be located at a variety of locations in a medical or research environment, for example, but not limited to, clinical laboratories, hospitals, other inpatient settings, a clinician's office, ambulatory settings, medical billing and financial offices, hospital administration, veterinary environment, and home healthcare environment. Clinicians include, but are not limited to, the treating physician, specialists such as surgeons, radiologists and cardiologists, emergency medical technicians, physician's assistants, nurse practitioners, nurses, nurse's aides, pharmacists, dieticians, microbiologists, laboratory experts, genetic counselors, researchers, veterinarians, students, and the like. The remote computers may also be physically located in nontraditional medical care environments so that the entire healthcare community is capable of integration on the network. Remote computers 28 may be a personal computer, server, router, a network PC, a peer device, other common network node healthcare device or the like, and may include some or all of the elements described above relative to server 22. The devices can be personal digital assistants or other like devices. Computer network 26 may be a local area network (LAN) and/or a wide area network (WAN), but may also include other networks including Internet networks via wired or wireless capability. Such networking environments are commonplace in offices, enterprise-wide computer networks, intranets and the Internet. When utilized in a WAN networking environment, server 22 may include a modem or other means for establishing communications over the WAN, such as the Internet. In a networked environment, program modules or portions thereof may be stored in server 22, or database cluster 24, or on any of the remote computers 28. By way of example, and not limitation, various application programs may reside on the memory associated with any one or all of remote computers 28. It will be appreciated that the network connections shown are exemplary and other means of establishing a communications link between the computers may be used.

A user may enter commands and information into server 22 or convey the commands and information to the server 22 via remote computers 28 through input devices, such as keyboards, pointing devices, commonly referred to as a mouse, trackball, or touch pad. Other input devices may include a microphone, satellite dish, scanner, or the like. Commands and information may also be sent directly from a remote healthcare device to the server 22. Server 22 and/or remote computers 28 may have any sort of display device, for instance, a monitor. In addition to a monitor, server 22 and/or computers 28 may also include other peripheral output devices, such as speakers and printers.

Although many other internal components of server 22 and computers 28 are not shown, those of ordinary skill in the art will appreciate that such components and their interconnection are well known. Accordingly, additional details concerning the internal construction of server 22 and computer 28 need not be disclosed in connection with the present invention.

Although the method and system are described as being implemented in a WINDOWS operating system, operating in conjunction with an Internet-based system, one skilled in the art would recognize that the method and system can be implemented in any system. As contemplated by the language above, the method and system of the present invention may also be implemented on a stand-alone desktop, personal computer, or any other computing device used in a medical environment or any of a number of other locations.

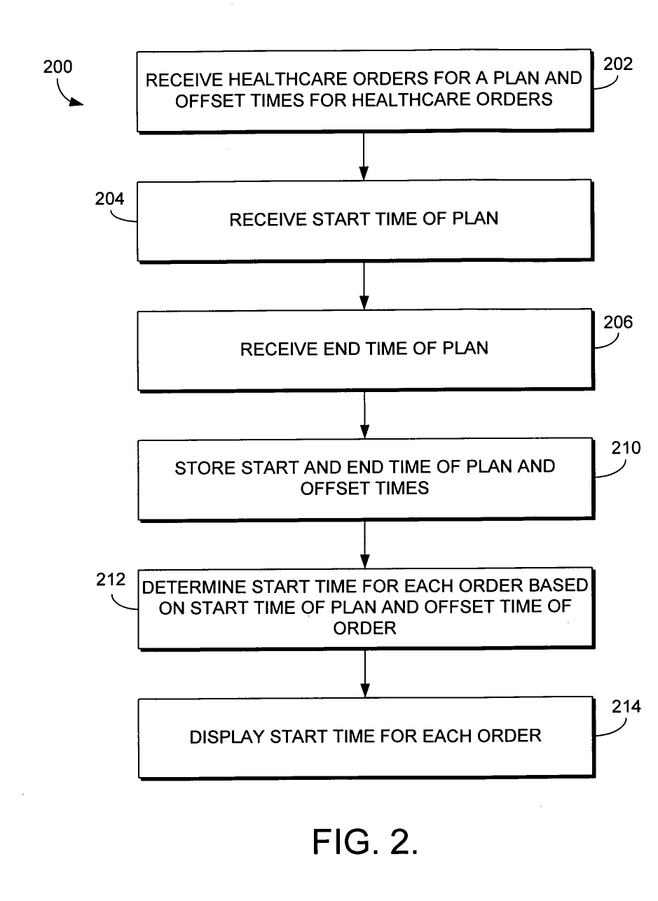

With reference to FIG. 2, a method 200 for creating an offset time between the start time of a healthcare plan and the offset time of each of the orders in the plan is shown. At block 202, the healthcare orders for a healthcare plan are received. A health plan includes a number of orders. The healthcare orders may be requests for any of a variety of healthcare related tests, procedures, treatments, diagnostics, or medication. For example, a healthcare plan may comprise two laboratory tests and three medications to be administered to patient. The healthcare plan may be chosen by a healthcare provider for the patient based on the patient's condition. The healthcare plan may be a predefined plan containing certain orders for treating a condition or ailment. Alternatively, a healthcare provider may select orders individually to develop an individualized healthcare plan for treating a problem or ailment of a patient. “Also, healthcare plan may include a number of other plans. For example, a plan may consist of a number of smaller plans (or phases) comprising orders.

Also received at block 202 are the offset times for each of the healthcare orders in the healthcare plan. The offset time (or offset time period) for an order is the difference between the start time of the plan and the time at which the order should begin. For example, one of the laboratory tests in the healthcare plan has an offset time period of twenty-four hours from the start date and time of the healthcare plan, while a medication in the healthcare plan has an offset time of ten days after the start of the healthcare plan. If the healthcare plan is a predefined healthcare plan with predefined orders and suggested offset times, these offset times are received. However, a healthcare provider may change the suggested offset times as needed. Alternatively, a healthcare provider who develops his or her own healthcare plan for a particular condition by manually selecting orders for the plan may manually select offset times for the orders selected.

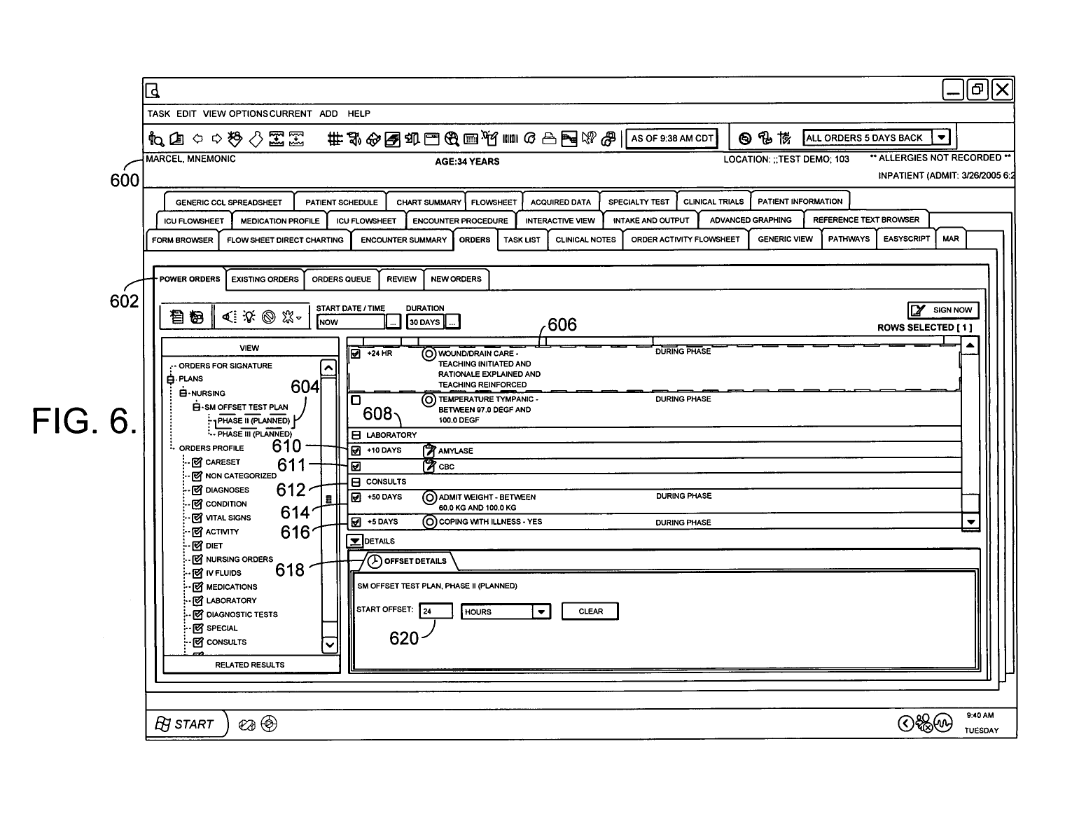

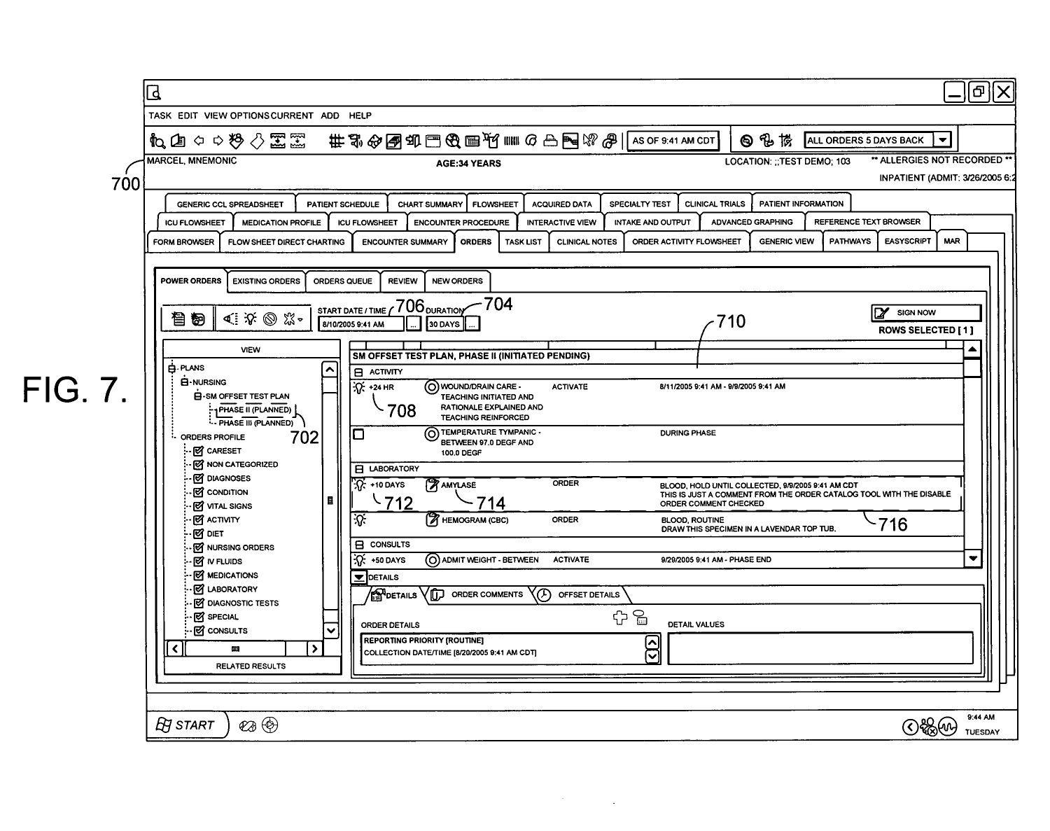

By way of example, and not by limitation, with reference to FIG. 6, an exemplary healthcare plan is shown. The plan comprises orders for wound treatment laboratory testing and consults. In this case, the “SM Offset Test Plan” includes two plans (or phases) containing orders. Each of these orders was predefined in a nursing plan in the system. In the display of FIG. 6, a healthcare plan entitled has been Phase II selected for a fictitious patient, Mnenomic Marcel 600, by his healthcare provider based on his condition. The healthcare plan can be seen in display 602 as phase II 604 of the larger nursing plan for the patient. The phase II plan 604 comprises orders for wound care treatment 606, two laboratory tests 608 (amylase 610 and CBC 611) and two consults 612 (admit weight 614 and copying with illness 616). The consult orders 612 need to be performed for the patient according to the plan. Consult 614 is set to occur fifty days from the start of the plan and consult 616 is designated to begin five days after the start of the plan. The fifty day time period and the five day time period are the offset times for order 614 and order 616, respectively. The offset details for an order of the healthcare plan are shown in display 618. For example, the wound care treatment order 606 has an offset start time 620 of twenty-four hours after the beginning of the phase II plan. 100311 Referring again to FIG. 2, at block 204, the start time of the healthcare plan is received. At block 206, the end time of the plan is received. The start and date time of the plan are entered by the healthcare provider depending on when the provider wants treatment of the patient to begin. For example, with reference to FIG. 7, a display of a healthcare plan ordered for fictitious patient, Mnemonic Marcel, by a healthcare provider is shown. The start date and time 706 of the plan is shown. In this example, the start date and time of the plan is Aug. 10, 2005 at 9:41 a.m. The duration 704 of the plan is thirty days. As such, the end of the plan would be thirty-days from the start date 706.

Referring again to FIG. 2, at block 210, the start time of the plan and offset times for each of the orders are stored in a database or table. These can be accessed if any changes are made to the healthcare plan, the start time of the plan, or offset time of any of the orders in the plan. At block 212, the start time for each order is determined based on the start time of the plan and the offset time for each order. The start date and time for each order are displayed at block 214.

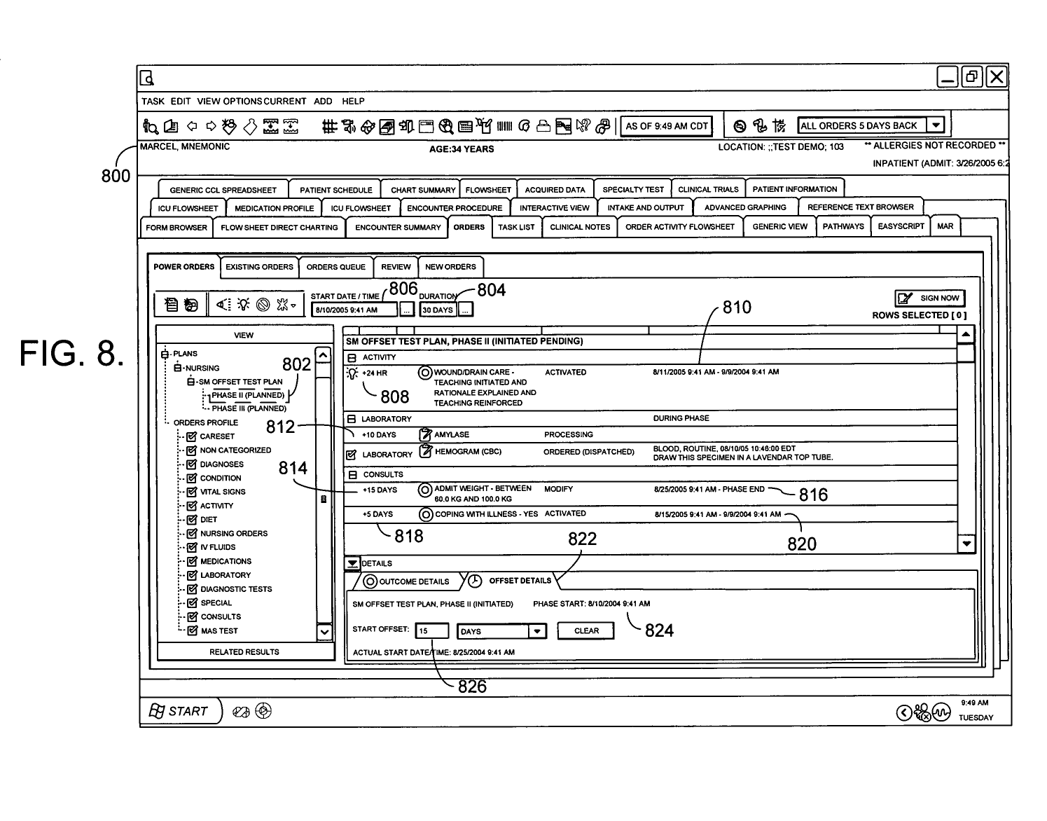

By way of example, and not by limitation, with reference to FIG. 8 a screen display 800 showing start times for orders for a healthcare plan 802 is shown. The healthcare plan has a start date and time 806 of Aug. 10, 2005 at 9:41 a.m. and a duration 804 of thirty days. The start date and times for orders 808, 812, 814, and 818 are calculated and displayed in the screen 800. The offset time between the start of the plan 806 and wound/drain care treatment order 808 is twenty-four hours. The start time of the wound/drain care treatment order 808 is calculated as Aug. 11, 2005 at 9:41 a.m. This is 24 hours after the start date and time 806 of the plan of Aug. 10, 2005 at 9:41 a.m. The consult 814 has an offset time of fifteen days. Thus, the start date and time of Aug. 25, 2005 at 9:41 a.m (816). This is 15 days after the start date and time of the plan 802. Consult 818 has an offset time of five days and should start on Aug. 15, 2005 at 9:41 a.m. (820). This is five days after the start date and time of the plan 806.

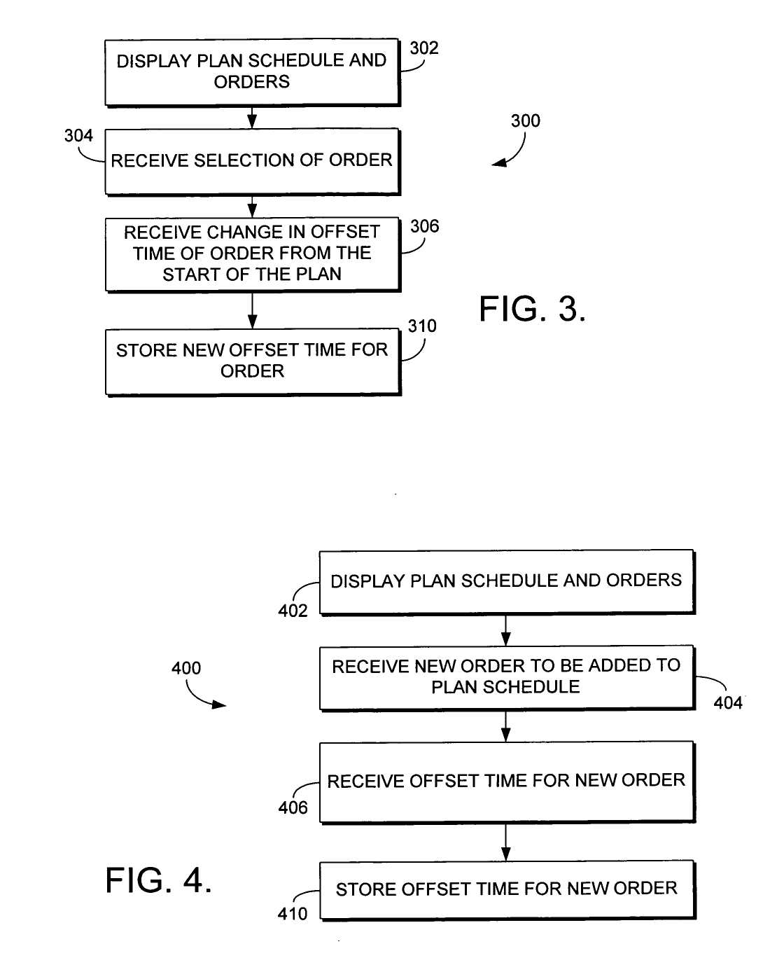

With reference to FIG. 3, a method 300 for changing the offset time between the start of a plan and the offset time of an order within the plan is shown. At block 302, the plan schedule and orders of the plan for a patient are displayed. At block 304, the selection of an order is received. The order may be selected by a user or healthcare provider to make changes to the offset time to the order. At block 306, the change in the offset time of the order is received. At block 310, the new offset time for the order is stored.

With reference to FIG. 8, the offset time for the admit weight consult order in healthcare is changed. It was changed from fifty days (as shown in FIG. 7) after the start of the plan to fifteen days after the start of the plan. In FIG. 8, the admit weight order 814 is selected by the user so that the offset time can be changed. The offset details 822 for the admit weight order 814 are displayed. The admit weight order 814 offset time is changed from fifty days after the start date of the plan (as shown in FIG. 7) to fifteen days (826) after the start of the phase II plan 824. The offset time change for admit weight order 814 is stored and the new start time 816 for the order 814 is determined by using the start date and time 806 of the plan and the new offset time 826 for order 814.

With reference to FIG. 4, a method 400 for creating an offset time between the start of a plan and the offset time of a new order is shown. At block 402, the plan schedule and orders of the plan are displayed. At block 404, the system receives a new order to be added to the plan schedule. For instance, a healthcare provider may choose to add an additional order to the plan that was not contained in the predefined plan or added subsequently. At block 406, the offset time for the new order is received. At block 410, the offset time for the new order is stored. By way of example, but not by limitation, a new order could be added to plan 802 of FIG. 8 by user by adding order, selecting an offset time and storing the order and associated offset time for the new order.

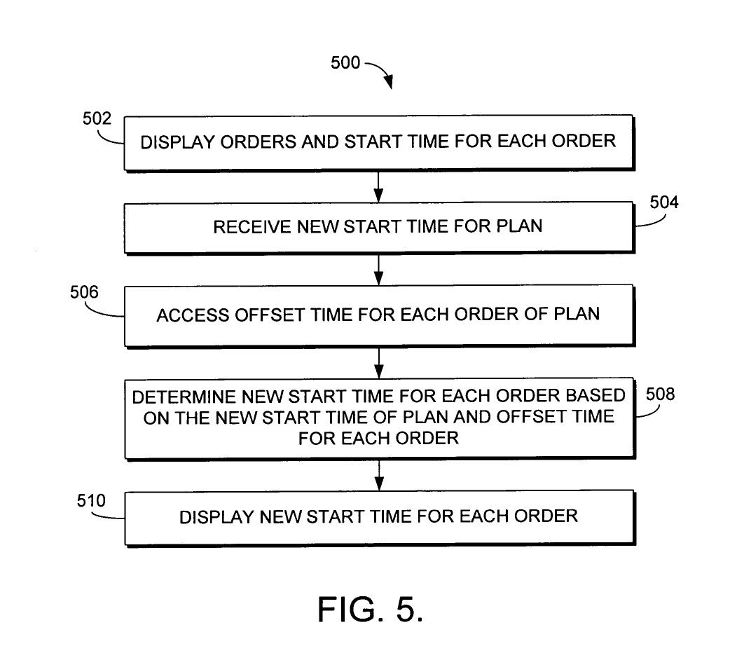

With reference to FIG. 5, a method 500 for determining the new start date and time for each order based on a new start time of the plan is shown. At block 502, the orders in the plan are displayed along with the start date and time for each of the orders. At block 504, a new start time for the plan is received. At block 506, the offset times for each of the orders in the plan are accessed. At block 508, based on the new start time for the plan and the offset time for each, the new start time for each of the orders in the plan is determined.

For example, with reference to FIG. 8, if the start date and time 806 of the plan is to Aug. 11, 2005 at 9:41 a.m., the wound/drain care treatment 808 would have a new me of Aug. 12, 2005 at 9:41 a.m. instead of Aug. 11, 2005. At block 510, of FIG. 5 start time for each order is displayed. This way the start date and time for the plan can be easily modified, and all of the orders for the plan and start times for all the orders of the plan easily modified using the offset time.

The present invention has been described in relation to particular embodiments, which are intended in all respects to be illustrative rather than restrictive. Alternative embodiments will become apparent to those skilled in the art but do not depart from its scope. Many alternative embodiments exist, but are not included because of the nature of the invention. A skilled programmer may develop alternative means for implementing the aforementioned improvements without departing from the scope of the present invention.

It will be understood that certain features and subcombinations of utility may be employed without reference to features and subcombinations, and are contemplated within the scope of the claims. Not all blocks in the various figures need to be carried out in the specific order described.

The invention claimed is:

1. A method for determining the start time of one or more healthcare orders in a computing environment, the method comprising:
receiving a start time of a healthcare plan, the plan comprising two or more healthcare orders for a patient;
receiving a first offset time for a first healthcare order in the healthcare plan, the first offset time being the difference between when the healthcare plan begins and when the first healthcare order begins; and
determining a start time of the first healthcare order based on the start time of the healthcare plan and the first offset time for the first healthcare order.

2. The method of claim 1, further comprising:
displaying the start time of the first healthcare order.

3. The method of claim 1, further comprising:
receiving a second offset time for a second healthcare order in the healthcare plan, the second offset time being the difference between when the healthcare plan begins and when the second healthcare order begins.

4. The method of claim 3, further comprising:
determining the start time of the second healthcare order based on the start time of the healthcare plan and the second offset time for the second healthcare order.

5. The method of claim 1, wherein the first start time of the first healthcare order is when the first healthcare order should begin.

6. The method of claim 1, wherein the first start time of the first healthcare order is when the first healthcare order may begin.

7. The method of claim 1, wherein the first healthcare order is for one of a medication, diagnostic test, laboratory test, consult, nursing care item, and healthcare procedure.

8. The method of claim 1, further comprising:
storing the first offset time for the first healthcare order and the start time of the healthcare plan.

9. The method of claim 1, wherein the first offset time for the healthcare order and the start time of the healthcare plan are stored in an electronic medical record for the patient.

10. The method of claim 1, wherein the healthcare plan is predefined healthcare plan having predefined healthcare orders and offset times for the orders.

11. The method of claim 10, wherein the predefined healthcare plan has been selected by a user.

12. The method of claim 1, wherein the healthcare plan comprises individual healthcare orders selected by a user.

13. The method of claim 12, wherein the offset times for the individual healthcare orders are entered by a user.

14. The method of claim 1, further comprising:
receiving a new start time for the healthcare plan.

15. The method of claim 14, further comprising:
determining a new start time for the first healthcare order based on the new start time of the healthcare plan and the first offset time for the first healthcare order.

16. The method of claim 15, further comprising:
displaying the new start time for the first healthcare order.

17. The method of claim 16, further comprising:
receiving a new offset time for the first healthcare order, the new start time being the difference between when the healthcare plan begins and when the first healthcare order should begin.

18. The method of claim 17, further comprising:
determining a new start time of the first healthcare order based on the start time of the healthcare plan and the new offset time for the first healthcare order.

19. The method of claim 18, further comprising:
displaying the new start time of the first healthcare order.

20. A computer readable medium comprising the method of claim 1.

21. A computer program comprising the method of claim 1.

22. A system for determining the start time of one or more healthcare orders in a computing environment, the system comprising:
a first receiving component for receiving a start time of a healthcare plan, the plan comprising two or more healthcare orders for a patient;
a second receiving component for receiving a first offset time for a first healthcare order in the healthcare plan, the first offset time being the difference between when the healthcare plan begins and when the first healthcare order begins;
a determining component for determining a start time of the first healthcare order based on the start time of the healthcare plan and the first offset time for the first healthcare order.

23. The system of claim 22, further comprising:
a displaying component for displaying the start time of the first healthcare order.

24. The system of claim 22, wherein the first receiving component receives a second offset time for a second healthcare order in the healthcare plan, the second offset time being the difference between when the healthcare plan begins and when the second healthcare order begins.

25. The system of claim 24, wherein the determining component determines the start time of the second healthcare order based on the start time of the healthcare plan and the second offset time for the second healthcare order.

26. The system of claim 22, wherein the first healthcare order is for one of a medication, diagnostic test, laboratory test, consult, nursing care item, and any healthcare procedure.

27. The system of claim 22, further comprising:
a storing component for storing the first offset time for the first healthcare order and the start time of the healthcare plan.

28. The system of claim 27, wherein the first offset time for the healthcare order and the start time of the healthcare plan are stored in an electronic medical record for the patient.

29. The system of claim 22, wherein the first receiving component receives a new start time for the healthcare plan.

30. The system of claim 29, wherein the determining component determines new start time for the first healthcare order based on the new start time of the healthcare plan and the first offset time for the first healthcare order.

31. The system of claim 30, further comprising:
a displaying component for displaying the new start time for the first healthcare order.

32. The system of claim 22, wherein the first receiving component receives a new offset time for the first healthcare order, the new start time being the difference between when the healthcare plan begins and when the first healthcare order should begin.

33. The system of claim 32, wherein the determining component determines a new start time of the first healthcare order based on the start time of the healthcare plan and the new offset time for the first healthcare order.

34. The system of claim 33, further comprising:
a displaying component for displaying the new start time of the first healthcare order.

35. A system for determining the start time of one or more healthcare orders in a computing environment, the system comprising:
means for receiving a start time of a healthcare plan, the plan comprising two or more healthcare orders for a patient;
means for receiving a first offset time for a first healthcare order in the healthcare plan, the first offset time being the difference between when the healthcare plan begins and when the first healthcare order begins;
means for determining a start time of the first healthcare order based on the start time of the healthcare plan and the first offset time for the first healthcare order.

36. The system of claim 35, further comprising:
means for displaying the start time of the first order.

37. The system of claim 36, further comprising:
means for storing the first offset time and the start time of the plan.

38. The system of claim 35, wherein the first healthcare order is for one of a medication, diagnostic test, laboratory test, consult, nursing care item, and any healthcare procedure.

39. The system of claim 35, further comprising:
means for receiving a new start time for the healthcare plan.

40. The system of claim 39, further comprising:
means for determining a new start time for the first healthcare order based on the new start time of the healthcare plan and the first offset time for the first healthcare order.

41. The system of claim 35, further comprising:
means for receiving a new offset time for the first healthcare order, the new start time being the difference between when the healthcare plan begins and when the first healthcare order should begin.

42. The system of claim 41, further comprising:
means determining a new start time of the first healthcare order based on the start time of the healthcare plan and the new offset time for the first healthcare order.
